(19) United States
(12) Patent Application Publication
(10) Pub. No.: US 2012/0214526 A1
(43) Pub. Date: Aug. 23, 2012

(54) Trusted Paired-Device Initial Connection Assistance

(75) Inventors: Yngve Selén, Uppsala (SE); Jonas Kronander, Uppsala (SE)

(73) Assignee: TELEFONAKTIEBOLAGET LM ERICSSON (PUBL), Stockholm (SE)

(21) Appl. No.: 13/505,304

(22) PCT Filed: Nov. 5, 2009
(86) PCT No.: PCT/SE2009/051254

§ 371 Date: May 1, 2012

(51) Int. Cl. H04W 76/02

(52) U.S. Cl. 455/507

(57) ABSTRACT

The present invention relates to a solution for wireless communication and in particular for facilitating connection to a radio access network. This is provided in a number of aspects such as method, devices, and system. The solution comprises using a local short range communication connection between two user equipments, UEs, (101, 102) for assisting each other in connecting to a radio access network, RAN (103). One UE is often an always on UE and one is often a sporadic use UE. The always on UE has normally an active connection with the RAN and has knowledge about valid radio access technologies, RAT. The sporadic use UE may connect with the always on UE with a trusted connection and negotiate for information about available RATs and use this information for faster connection with the RAN. The two UEs may together scan for available RATs by dividing frequency bands and each searching different parts and thus reducing the scan process and reducing resource use.

### TECHNICAL FIELD

The present invention relates to a solution for wireless communication and in particular for facilitating connection to a radio access network.

### BACKGROUND

The number of radio access technologies available for uses such as cellular telephony and mobile broadband has grown rapidly in the recent years. In the beginning of the 1990s there were only a few standards available, such as NMT, GSM and IS-95, used almost exclusively for voice telephony. Currently, many additional radio access technologies (RATs) have been developed, such as W-CDMA, CDMA2000, EDGE, IEEE 802.15 or 16, and LTE, to mention a few. Customers also demand multi-mode terminals, for improved coverage and to be able to use their terminals when traveling, so that a single terminal must be able to use several of the above RATs.

To add to the heterogeneous situation there is a regulatory interest to become increasingly flexible in the spectrum allocations. The advantage of this is that the radio environment can be adapted to the current usage patterns and thus the limited radio resources may possibly be more efficiently exploited. This could mean that, in the future, different RATs will be allocated to different frequencies in different locations and that these allocations may change over time.

As long as a user equipment (UE) is switched on, the frequency allocations for different spatial and temporal locations can be continuously updated by the network and communicated to the UE. However, a UE that is switched on in an unknown environment must perform a scanning of frequencies to find appropriate RATs before it can initiate a connection. As both the number of available RATs and frequency bands that a UE supports are expected to increase in the future, this scanning will become increasingly more complex and may take increasingly longer time, which furthermore could use up a significant part of a UE's battery before a connection can be established. If also the frequency allocations become more dynamic, also within a country, this switch-on scenario in an unknown environment may become an increasingly large problem, particularly for UEs which are expected to switch on and off often, such as for instance portable computers, personal digital assistants (PDA's), or media machines, e.g. music players or film players.

One may divide UEs into two different categories:

Always on UEs:

Members of this category of UEs are only seldom switched on and off. Typical examples are cellular phones. For this category, the time between switch-on and connection is not a significant issue, since switch-on is such a rare event. If the spectrum conditions change during the UE operation, it is assumed that the network can provide the UE with new spectrum information and make the appropriate handover.

Sporadic use UEs:

Members of this category of UEs experience switch-on and switch-off often. A typical example is laptops with wireless broadband modems. For this UE category long scanning times can be a great nuisance to the users: users are not likely to accept waiting times on the order of minutes before they can connect to the network and start using their wireless broadband connection.

Since all laptop computers are expected to have mobile broadband in the future, we expect the sporadic use UE category to become more common. It is of vital importance for the user experience to keep down the time it takes for members of this UE category to connect. The present invention has the goal of reducing the connection time for this UE category.

Currently, UEs keep a database on their latest connections and first try to find the RATs at the frequencies where they appeared last time. In a relatively static frequency environment, such as the frequency environment of today, this usually works satisfactory. In this case it is only seldom that a UE has to initiate a complete scanning process of the spectrum since it almost always finds its latest RAT at the latest frequency. However, a user which makes many international travels may experience long scanning times as the spectrum environment shifts between different countries. This will likely be accepted by users. However, in a future dynamic frequency environment, where RATs may shift frequencies, to satisfy the local needs both temporally and spatially, long scanning times may become a significant barrier to user satisfaction. This problem will particularly be a nuisance for sporadic use UEs.

Another way is to solve the problem with long scanning times is to introduce a RAT at a harmonized frequency band (ideally, globally harmonized) from which the UEs can request information on the spectrum situation in their current locations. This solution is sometimes denoted beacon, and sometimes denoted out-band Cognition enabling Pilot Channel (CPC). While this may sound like an attractive idea which could facilitate short connection times, the approach has several problems. First, it requires the build-up and management of a large infrastructure for supplying good coverage of this particular RAT.

This will be both complex and expensive. It is also not certain who would manage such an important RAT and how fairness in exposure between different operators will be ensured. Second, it requires the UEs to support yet another RAT at yet another frequency, which will necessarily increase UE complexity and thus production cost and consumer price. This could be a significant issue for low-cost UEs. Furthermore, it is envisaged that the out-band CPC cells cover a large area to keep the number of cells down. In these CPC cells the radio environment may not be homogeneous. Thus this approach may also place the additional requirement of positioning on the UEs, e.g., via GPS, such that a UE will be able to extract the information relevant for its current location. This further increases the UE complexity.

The UE database solution will become increasingly less attractive as the frequency environment complexity increases. The out-band CPC/beacon is a very complex and expensive way for solving the problem of initial connection times. It also raises many additional questions on management and fairness.

### SUMMARY

It is therefore an object of the present invention to provide solutions that obviates at least some of the above disadvantages and provides a method for facilitating connection to a radio access network. Many users have at least two user equipments. It is also probable that these UEs have some sort of paired “trusted device” relationship; e.g., the devices are likely to communicate directly to synchronize calendar and email, transfer files, etc. This type of communication is usually performed in the ISM bands using some short-range technology, e.g. Bluetooth or WLAN. Since the two UEs have this paired trusted relationship, they may have agreed upon certain frequency bands and/or radio access technologies, RATs, and configurations to facilitate a rapid connection. This means that one UE may quickly find the other UE, and obtain necessary information for network connection from it. In this way the solution has an advantage of that a lengthy and energy consuming scanning process may be avoided in many cases.

The present invention is exemplified in a number of aspects in which a first is a method for facilitating connection to a radio access network. The method comprises steps of determining in a first device that a connection to a radio access network is to be established, transmitting from the first device to a portable second device a request for obtaining a list of valid radio access network communication configurations using a personal area network, i.e. PAN, wireless communications protocol, obtaining the list of valid network communication configurations, and using in the first device information from the list for connecting to the radio access network using a cellular wireless communication protocol.

An advantage with this solution is that access to the radio access network may be provided without the need for time and battery power consuming extended searches for valid networks.

Advantageously, the method may further comprise an initial step of pairing the first and second devices to each other and thus providing a possibility of a secure and trusted link between the paired devices. One example of a pairing process may comprise setting up a communication link between the first and second device, transmitting from the first device a pairing request to the second device, updating a radio access technology connection information, i.e. RCI, server list with information related to the first device, transmitting from the second device a pairing response to the first device receiving in the first device the pairing response, and storing in the first device information related to the second device in an RCI client list.

Network communication configurations may for instance comprise information relating to at least one of communication frequency and radio access technology. The use of the pairing relationship in relation to connection may for instance be triggered by at least one of device start up, communication unit start up, lost network connection, failed connection, or time out of connection.

By the pairing mechanism the UEs may advantageously quickly and securely exchange the list of valid network communication configurations.

It should be appreciated that if no information about available network communication configurations is received from the second device, the first device may instead start a full radio access technology communication search or use information about last connection(s) stored in the first device.

Furthermore, the devices may communicate with each other for receiving in the first or second device a message from the other device, the message indicating a range of communication spectrum to scan for connection, and for sharing the result of the scanning with the other device. This may be advantageous since the scan time may be significantly reduced and battery power consumption reduced for each device.

The transmissions between the first and second devices may be at least one of certified and/or encrypted in order to make sure that the information is received from a trusted device which would advantageously reduce the risk of the RCI pointing towards a bad, non-trusted, insecure, and/or expensive network.

Furthermore, a client device in the wireless communication network determines that a connection needs to be established. The device comprises a processor, a computer readable memory, and at least one communication interface. The processor may be arranged to execute instruction sets stored in the computer readable memory and using the at least one communication interface for transmitting to a portable second device a request for obtaining a list of valid radio access network communication configurations using a personal area network, i.e. PAN, wireless communications protocol, obtaining the list of valid network communication configurations, and using in the first device information from the list for connecting to the radio access network using a cellular wireless communication protocol.

The portable second device may be seen as a server device in a wireless communication network. The server device may comprise a processor, a computer readable memory, and at least one communication interface. The processor may be arranged to execute instruction sets stored in the computer readable memory and using the at least one communication interface for receiving a request from the client device using the personal area network, i.e. PAN, wireless communications protocol for obtaining a list of valid radio access network communication configurations, and transmitting the list of valid network communication configurations to the client device.

Furthermore, the client and server devices may together form a system facilitating initial connection to a wireless communication network.

The advantages of the present invention may be summarized as follows. Since, the solution according to the present invention provides a possibility to exchange connection information with a paired device comprising information about available networks and valid network configurations, it may remove or at least reduce the need for time and battery consuming spectrum scanning for available RATs for a UE that is often switched on and off. This may be achieved without the need for large infrastructure investments and massive regulatory lobbying and control, as is the case for outband CPC. In particular the invention significantly simplifies the RAT detection in multiple dynamic RAT environments where the spectrum occupancy of the RATs is often changing, and for scenarios where the UE is often switched on in different locations with different spectrum allocations for the RATs.

Furthermore, by providing the possibility to exchange and agree upon scan spectrum ranges between the devices, the invention provides a reduction of average spectrum scanning time, whenever a spectrum scanning becomes necessary, and the average scanning time may be decreased by a factor N, by using N devices in a cooperative spectrum scanning.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates schematically a network according to the present invention;

FIG. 2 illustrates schematically a method according to the present invention;

FIG. 3 illustrates schematically a method according to the present invention; and

FIG. 4 illustrates schematically a device according to the present invention.

### DETAILED DESCRIPTION

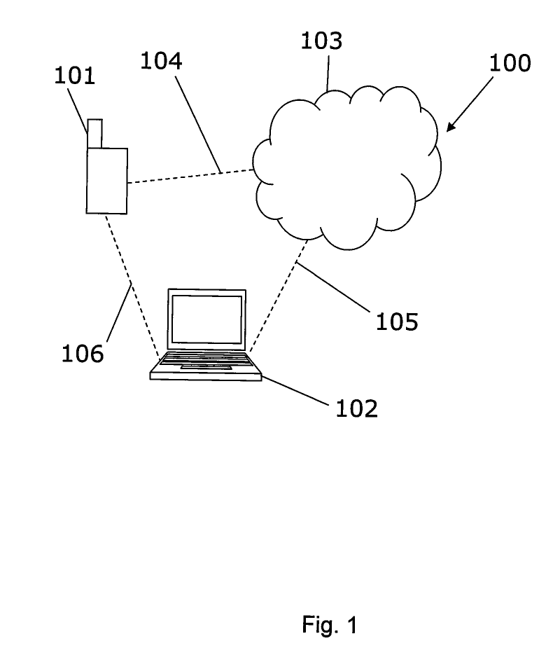

In FIG. 1 reference numeral 100 generally denote a network configuration according to the present invention. A user equipment (UE) 101, e.g. an often used or “always on” UE, may connect wirelessly to a Radio Access Network (RAN) 103 using some suitable Radio Access Technology (RAT) 104. Another UE 102, e.g. a sporadic use UE, may also connect to the RAN 103 using some suitable RAT 105 which may be different from the RAT 104 used by the always on UE 101. The sporadic use UE 102 and the always on UE 101 may communicate with each other using some suitable communication technology 106 which may be wireless or wired; this will be discussed further later in this document. The always on UE may be for instance a portable device such as a mobile/cellular phone or a smart phone and the sporadic use UE may for instance be stationary device or a portable device such as a laptop, netbook, or personal digital assistant (PDA).

The Radio Access Technology used by the always on and/or sporadic use UE may be any suitable type, e.g. GERAN, UTRAN, EUTRAN, WRAN (IEEE 802.22 series), WLAN (IEEE 802.11 series), or WiMAX (IEEE 802.16 series).

The connection between the always on and sporadic use UE may be any type enabling direct communication with each other and forming a personal area network (PAN) between them; in the case wired connection an Ethernet link or serial link such as USB may be used and in the case of wireless connection the devices may use for instance Bluetooth (IEEE 802.15 series), IrDA, Ultra Wideband (UWB), Z-Wave, WLAN, or ZigBee network. It should be noted that even though WLAN is not always considered for use in a PAN it may be used for this purpose. In FIG. 1 two devices are shown, but it should be appreciated that two or more devices may together form the PAN. Any type of wireless or wired connection that may form a direct link between parties of the PAN may be used.

In this document we will use the abbreviation RCI, RAT Connection Information, to denote the information on which RATs are available at what frequencies. A specific UE only has a need for a subset of the total RCI of a location, since the supported RATs and frequency bands are limited in the UE. Usually in the text, the RCI refers to the RCI which is related to a certain UE. We will also use the term “RCI pairing”, or “pairing” for short, which is defined as the action when two communication devices establish a trusted communication relation by exchanging information such that the preferences of one is known to the other. Two devices are said to be “RCI paired”, or “paired”, when they have gone through a RCI pairing. Most often a sporadic use UE and an always on UE, will go through RCI pairing and be RCI paired, such that the preferences of the sporadic use UE (or RCI client) are known to the always on UE (or RCI server).

The devices forming the PAN need to connect to each other for exchange of RCI and this process may be described as an RCI pairing process, which enables one of the paired devices to act as an RCI server, and supply the other device(s), thereby acting as an RCI client(s), with relevant valid RCI. The valid RCI relate to information useable for connecting to valid radio access network communication configuration. A “valid radio access network communication configuration” is a configuration that enables the radio unit in the device to successfully establish a connection to a specified RAT. This configuration should at least comprise the necessary parameters needed to establish a connection to the RAT under consideration and “valid radio access network communication configurations” is a set of configurations, comprising at least one “valid radio access network communication configuration”.

If more than two devices are used for forming the PAN, they may use the same or different access technologies, e.g. one client may use a Bluetooth connection and another client may use a wired connection towards each other or the server.

Some legacy RAT or fixed connection is normally available for communication between the two devices. This can be, e.g., Bluetooth, WLAN or some other RAT as discussed earlier. First, the two devices establish their roles in the exchange of RCI information and learn about the capabilities of the other device. In this process, the devices' relation is asymmetric with two different roles: RCI client (the device which later requests RCI data) and RCI server, the device which supplies the RCI data to the RCI client. The two devices may be servers and clients to one another.

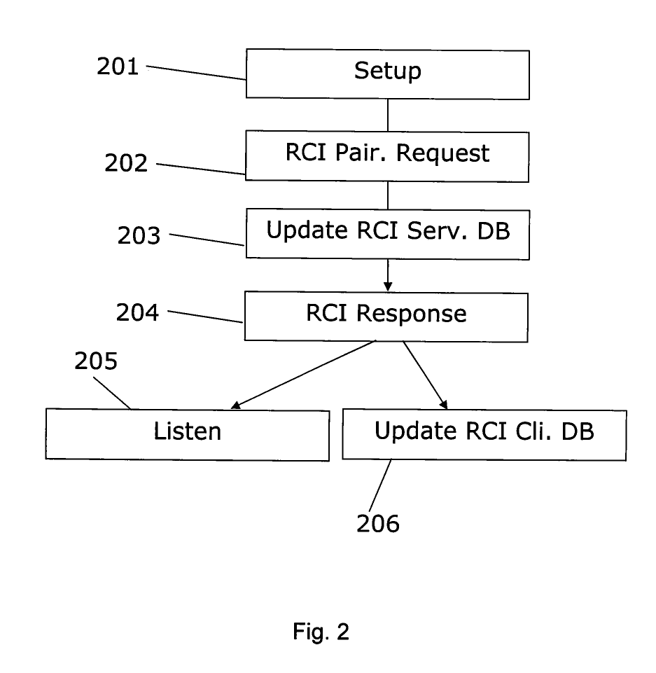

The RCI server keeps a database with information on the RCI clients which are entrusted RCI information. Similarly, the RCI client keeps a database on which devices it trusts to receive RCI information from. In the RCI pairing phase, illustrated in FIG. 2, the devices first set up the communication 201. The devices may already in this step handle security issues, such as storing certificates for certification of the devices and encryption for their communication, if deemed necessary. Such an entrusted connection is beneficial since this reduces the risk of connecting to a RAT not desired, such as belonging to an unwanted operator, not cost efficient, or even fraudulent RAT. The RCI client sends 202 a RCI pairing request message to the RCI server describing which RCI information it is interested in. This message may include prioritization between different RATs, information on how old RCI the client will accept (see below), the RCI update frequency, etc. Such a message may comprise message ID, Device ID, and requested information. The RCI server updates 203 an RCI server database with information on the RCI client and its preferred RCI. Should the client already exist in the database, the old RCI field is updated or replaced by the new. Should the client not exist in the database, a completely new entry is created, comprising the RCI client ID and its preferred RCI. The server then acknowledges the information and its successful entry in the database to the client by transmission 204 of an RCI pairing response message. Upon reception of the response the client updates 206 an RCI client database with the ID of the RCI server and the RCI that may be obtained from this RCI server, such as update frequency, RATs that the server may provide information about, etc. Such a response message may comprise message ID, device ID and RCI. The server will, every once in a while periodically or event driven, consult 205 the network by listening for the required RCI, and update its database with the relevant RCI at the current location. This enables the server to give a fast response to the client (the server need not consult the network prior to sending RCI to the client, provided its stored RCI is “fresh”), and also to give some response even if the server's connection to the network has been lost.

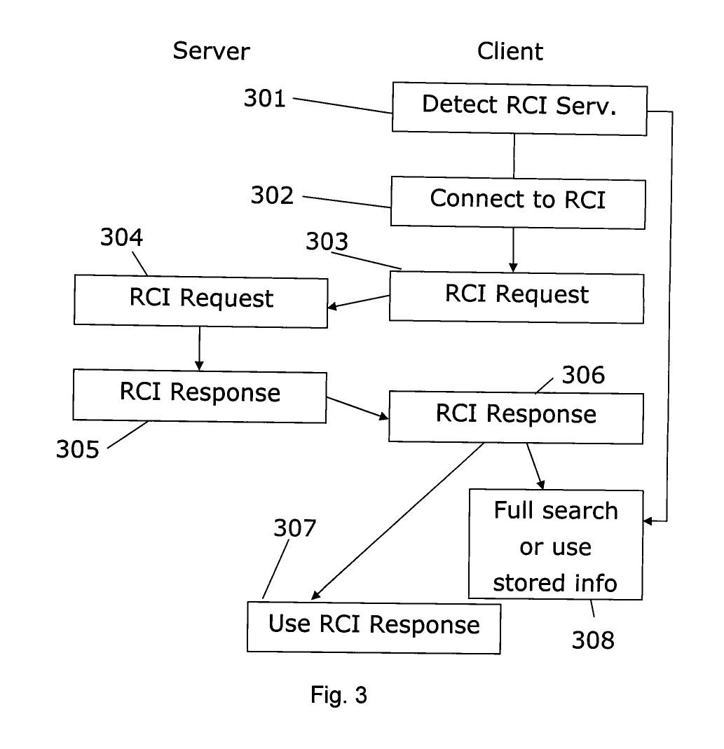

During normal operation, the devices have been paired and an RCI request from an RCI client (such as a Sporadic Use UE) to an RCI server (such as an always on UE) will be performed, e.g., when the RCI client needs to obtain valid RCI information in order to make a connection with the RAN. In the example described herein it is assumed that the RCI pairing has already been performed, however, the steps of RCI pairing and RCI request may be combined into a single process. One implementation of the RCI request phase is presented in FIG. 3. It should be appreciated that the RCI client may when connected also communicate with the access network or the RCI server to obtain suitable RCI information for future purposes.

First, the RCI client discovers a need for updated RCI information which triggers the RCI request process. This need may be for many reasons, such as device startup, communication unit start up, a lost network connection which needs to be re-established, a failed connection (e.g., the desired RAT is not available at its latest frequency), etc. The RCI client then looks 301 for the servers that are registered in its database. It then tries to establish 302 connections to the RCI servers in a standard manner, starting with the preferred RCI server. If no RCI servers are found, the device may, e.g., attempt to use information about earlier successful connection, or it has to resort to scanning the frequency spectrum 308. Once the connection is established an RCI request message may be transmitted 303 to request the RCI which has been specified during the RCI pairing phase. However, if the client, for some reason, desires some other information than the one specified in the RCI pairing phase, this may be also be specified in the RCI request message. An RCI request message may comprise message ID, device ID, and RCI request and optionally other RCI parameters specified. Once the server has received 304 and accepted an RCI request, it replies 305 with the requested RCI information or a message indicating that the requested information is not available this time if this is the case. All RCI data may be sent in one, as in the example presented in FIG. 3, or in several consecutive RCI response messages comprising message ID, device ID, RAT info number, part of data requested, and optionally number of additional response messages to complete the request. The receiving client receives 306 the response and may then use 307 the information in the reply message to connect to its desired RAT without initiating a time consuming scanning process. Should no trusted RCI servers be found, should the received information not be valid, or should only a message indication no valid RCI information available be obtained from the present RCI paired servers, the client may attempt to use old RCI information or some other information on earlier successful connections, or perform 308 a time and battery consuming spectrum scanning process in order to make a connection to the RAN, alternatively the client device may use information relating to connection stored in the device for trying to connect. Such information may comprise configuration parameters for earlier connections.

Should none of the RCI information sent from the RCI server(s) to the RCI client be valid, and should no other useful information on valid RATs be available, the RCI client needs to scan the spectrum for an appropriate connection. As already observed, such a scanning process may be both time and battery consuming. However, if the RCI client and server(s) support the same frequency bands and RATs, the RCI client, or (one of) the RCI server(s), may send a request for joint scanning to the other party.

If this joint scanning request is accepted, the RCI client and server(s) divide the RAT-frequency space to scan between them. In one embodiment they focus on spectrum bands and RATs which all or a majority of the scanning parties can use for connection. E.g., if the RCI server, assuming one server is present, supports WCDMA, LTE and GSM in the frequency space F1 and the RCI client supports WCDMA and LTE in the frequency space F2, they may decide to scan the intersection of F1 and F2 for the RATs WCDMA and LTE. Once one of the devices has found a RAT, it reports this to the other parties. Provided that one of the parties has been able to connect to a network, that party may request the network for valid RCI information, and transmit this to the other parties, which may then also connect using this RCI information, if desired. Note that it is not necessarily so that the client and server(s) use the same operator. Indeed, even if one of the parties finds a RAT which it is not able to connect to (since that RAT may belong to another operator), some other device active in the scanning process may be able to connect to that RAT, implying that it may still be interested in that information. This joint scanning process should, depending on the partition of the spectrum to be scanned by the involved entities and the individual hardware specifications, cut the average scanning time at least in half, since there are at least twice as many devices able to scan the spectrum. As described above, more than two devices may cooperate in this joint scanning, which may further reduce the required time to complete the scanning process.

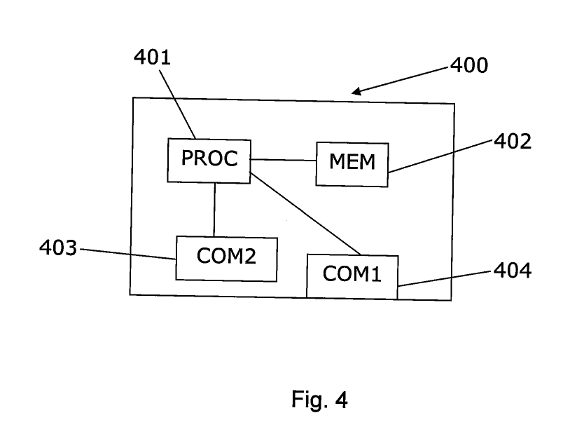

The pairing, RCI request/response, and joint scanning processes are performed as instruction sets in the devices. The devices 400 may both be illustrated by FIG. 4 and comprise as illustrated in FIG. 4 a processing unit 401, a computer readable storage medium 402, either volatile and/or non-volatile memory, at least one communication interface towards the RAN 404, and at least one communication interface towards the PAN 403. It should be appreciated that the two communication interfaces 403, 404 may be implemented into one single communication interface. The processing unit may comprise any type of processing device that may handle instruction sets—software or hardware instruction sets. Such processing devices may include central processing unit, micro processor, field programmable gate array (FPGA), or Application specific integrated circuit (ASIC). The processing unit 401 is arranged to read and execute instruction sets stored in the storage medium for handling the pairing, RCI request/response, and/or joint scanning features. The database comprising the RCI information may be stored in the storage medium.

It should be appreciated the term always on UE should not be interpreted literally but interpreted as a device which has a long term connection/attachment with the radio access network, e.g. a mobile phone and that the term sporadic use UE should be interpreted as a device which reconnects to the radio access network sporadically and has time periods there between which the UE is not attached to the radio access network, e.g. a laptop or smart phone as discussed earlier in this document. However, a mobile phone may also be connected sporadically to the radio access network under some circumstances and a laptop may also be connected with a long term connection. The devices connected in the PAN may use each other for determining if there is some available information about valid RCI for connecting to a radio access network.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be at least in part implemented by means of both hardware and software, and that several “means” or “units” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

### ABBREVIATIONS

CDMA2000 Code Division Multiple Access 2000, a wireless communications standard
CPC Cognition enabling Pilot Channel
DB Data Base
E2R End to End Reconfigurability
E3 End to End Efficiency
EDGE Enhanced Data rates for GSM Evolution
E-UTRAN Evolved Universal Terrestrial Radio Access Network
GERAN GSM/EDGE Radio Access Network
GSM Global System for Mobile communications
GPS Global Position System
IEEE Institute of Electrical and Electronics Engineers
ISM band Industrial, Scientific and Medical spectrum band
IP Internet Protocol
LTE Long Term Evolution
PAN Personal Area Network
RAN Radio Area Network
RAT Radio Access Technology
RCI RAT Connection Information
Rx Reception
Tx Transmission
UE User Equipment
UTRAN Universal Terrestrial Radio Access Network
UWB Ultra WideBand
WAN Wide Area Network
W-CDMA Wideband Code Division Multiple Access
WLAN Wireless Local Area Network
WRAN Wireless Regional Area Network

1-15. (canceled)

16. A method for facilitating connection to a radio access network, said method comprising:
determining in a first device that a connection to a radio access network is to be established;
transmitting from the first device to a portable second device a request for obtaining a list of valid radio access network communication configurations using a personal area network (PAN) wireless communications protocol;
obtaining the list of valid network communication configurations; and
using in the first device information from the list for connecting to the radio access network using a cellular wireless communication protocol.

17. The method of claim 16, further comprising an initial step of pairing the first and second devices to each other.

18. The method of claim 17, wherein the initial pairing comprises:
setting up a communication link between the first and second device;
transmitting from one of the first or second device a pairing request to the other device, the transmitting device being a pairing initiating device;
updating in the receiving device a radio access technology connection information (RCI) database with information related to the initiating device;
transmitting from the receiving device a pairing response to the initiating device;
receiving in the initiating device the pairing response; and
storing in the initiating device information related to the receiving device in an RCI database.

19. The method of claim 16, further comprising performing in the first device at least one of:
starting a full radio access network search; and
using information stored in the first device if no information about valid network communication configurations are received from the second device.

20. The method of claim 16, wherein the network communication configurations comprise at least one of communication frequency and radio access technology (RAT).

21. The method of claim 16, further comprising receiving in the first or second device a message from the other device, the message indicating a range of communication spectrum to scan for connection.

22. The method of claim 21, further comprising sharing the result of the scanning with the other device.

23. The method of claim 22, further comprising using the result of the scanning for establishing a connection to the radio access network.

24. The method of claim 16, wherein the PAN is one of a Bluetooth, IrDA, UWB, Z-Wave, WLAN or ZigBee network.

25. The method of claim 16, wherein the radio access network is one of GERAN, UTRAN, EUTRAN, WRAN, or WLAN.

26. The method of claim 16, wherein the transmissions between the first and second devices is at least one of certified and encrypted.

27. The method of claim 16, wherein the need for connection is triggered by at least one of device start up, communication unit start up, lost network connection, failed connection, or time out of connection.

28. A client device configured for use in a wireless communication network, said client device comprising:
a processor;
a computer readable memory; and
at least one communication interface;
wherein said processor is operatively associated with the computer readable memory and, via execution of instructions stored in the computer readable memory, the processor is configured to:
determine that a connection to a radio access network is to be established;
transmit, via said at least one communication interface, to a portable second device a request for obtaining a list of valid radio access network communication configurations using a personal area network (PAN) wireless communications protocol;
obtain the list of valid network communication configurations; and
use the list for connecting to the radio access network using a cellular wireless communication protocol.

29. A server device configured for use in a wireless communication network, said server device comprising:
a processor;
a computer readable memory; and
at least one communication interface;
wherein, via execution of instructions stored in the computer readable memory,
said processor is configured to use the at least one communication interface to:
receive a request from a client device using a personal area network (PAN) wireless communications protocol, said request for obtaining a list of valid radio access network communication configurations; and
transmit, in response to said request, the list of valid network communication configurations to the client device.

30. The server device of claim 29, wherein said server device is configured to form a trusted connection with the at least one client device.
